(19) United States
(12) Patent Application Publication
(10) Pub. No.: US 2019/0007451 A1
(43) Pub. Date: Jan. 3, 2019

(54) SYSTEM AND METHOD OF AUTOMATICALLY COLLECTING AND RAPIDLY AGGREGATING GLOBAL SECURITY THREAT INDICATORS TO CUSTOMER ENVIRONMENTS

(71) Applicant: STP VENTURES, LLC, Concord, NC (US)

(72) Inventors: Sheryl Pierce, Concord, NC (US); Marshall Wright, China Grove, NC (US); Patrick Wright, China Grove, NC (US)

(21) Appl. No.: 16/024,810

(22) Filed: Jun. 30, 2018

Related U.S. Application Data
(60) Provisional application No. 62/527,307, filed on Jun. 30, 2017.

(51) Int. Cl. H04L 29/06

(52) U.S. Cl. CPC H04L 63/1491; H04L 63/145; H04L 63/0245; H04L 63/10

(57) ABSTRACT

A method of providing internet security is provided that includes accessing and monitoring a list of online threat exchanges or indexes, wherein accessing the list occurs in real-time and is continuously updated, storing the monitored information at a server, monitoring at least one honeypot established by an operator of the server, wherein monitoring the honeypot occurs in real-time and is continuously updated, compiling a database based on the accessed list and monitored honeypot, and implementing a security measure based on the compiled database.

### CROSS-REFERENCE TO RELATED APPLICATIONS

The present application claims priority to and benefit from U.S. Provisional Patent Application Ser. No. 62/527,307 titled “A System and Method of Automatically Collecting and Rapidly Aggregating Global Security Threat Indicators to Customer Environments”, filed on Jun. 30, 2017, the content of which is incorporated by reference herein.

### TECHNICAL FIELD

The present disclosure relates to a system and method of internet security, and more specifically to a system and method of automatically collecting and rapidly aggregating global security threat indicators to customer environments.

### BACKGROUND

The internet represents an insecure channel for exchanging information leading to a high risk of intrusion or fraud, such as phishing. Internet security is a branch of computer security, specifically related to the internet, often involving browser security but also network security on a more general level as it applies to other applications or operating systems as a whole. The threats to the internet security include, but are not limited to, malware, computer viruses, computer worms, ransomware, scareware, spyware, Trojans and keyloggers.

Presently, there exist many software solutions that may monitor, detect and report threats to a network. However, such software solutions may not be very useful, as they generally rely on human involvement. Usually, threat reporting software sends a RSS Push to a user's computer in the form of an email. The email may include the URLs, IP addresses, Registered Domains, and file hashes associated with an attack. A security expert then has to parse all that information, research the threat, login to every perimeter security device (e.g. the firewall) and block those indicators manually.

An object of the present disclosure is to provide a system and method that provides internet security without manual intervention.

Another object of the present disclosure is to provide a system and method for automatically blocking malicious network content from entering into a customer network.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

Disclosed herein is a method of providing internet security. The method includes accessing and monitoring a list of online threat exchanges or indexes, where accessing the list occurs in real-time and is continuously updated. The method also includes storing the monitored list at a server and monitoring at least one honeypot established by an operator of the server, where the monitoring of the honeypot occurs in real-time and is continuously updated. The method also includes compiling a security database based on the accessed list and monitored honeypot, and instructing or implementing security measures based on the compiled database.

According to one or more embodiments, the method includes automatically updating the security database every 15 minutes.

According to one or more embodiments, implementing security measures comprises automatically blocking malicious content from entering into a customer network.

According to one or more embodiments, the security database is a database of one or more indicators that have been compromised.

According to one or more embodiments, the one or more indicators include at least one of IP addresses, URLs, and file hashes.

According to one or more embodiments, the file hashes are created using a CRC32 file hashing algorithm.

According to one or more embodiments, the method includes blending indicators from at least one threat exchange and a security analytics module into the security database and storing the security database on the server.

According to one or more embodiments, the method includes pushing indicators out though an SSH session to a firewall and automatically blocking a malicious site within an environment.

According to one or more embodiments, implementing security measures is executed through code of less than a thousand lines of scripted PHP and MySQL.

According to one or more embodiments, implementing security measures is executed through code in .sh scripts that executes CLI templates.

According to one or more embodiments, an internet security server includes a memory to store one or more instructions and a processor, in communication with the memory, configured to execute the one or more instructions. The server is configured to access and monitor a list of online threat exchanges or indexes, where accessing the list occurs in real-time and is continuously updated. The server is also configured to store the monitored list at the server and monitor at least one honeypot established by an operator of the server, where the monitoring of the honeypot occurs in real-time and is continuously updated. The server is also configured to compile a security database based on the accessed list and monitored honeypot, and implement a security measure based on the compiled database.

According to one or more embodiments, the security database is automatically updated every 15 minutes.

According to one or more embodiments, the security measure includes automatically blocking malicious content from entering into a customer network.

According to one or more embodiments, the security database is a database of one or more indicators that have been compromised.

According to one or more embodiments, the one or more indicators include at least one of IP addresses, URLs, and file hashes.

According to one or more embodiments, the file hashes are created using a CRC32 file hashing algorithm.

According to one or more embodiments, the security database is stored on the server and comprises a combination of indicators from at least one threat exchange and a security analytics module.

According to one or more embodiments, the processor is configured to execute instructions to push indicators out though an SSH session to a firewall and automatically block a malicious site within an environment.

According to one or more embodiments, the instructions comprise code of less than a thousand lines of scripted PHP and MySQL.

According to one or more embodiments, the instructions are executed through code in .sh scripts that execute CLI templates.

### BRIEF DESCRIPTION OF THE DRAWINGS

The foregoing, as well as the following Detailed Description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1 illustrates an environment, wherein various embodiments of the present disclosure can be practiced according to one or more embodiments of the presently disclosed subject matter.

FIG. 2 is a flowchart illustrating a method of providing internet security, according to one or more embodiments of the presently disclosed subject matter.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the presently disclosed subject matter.

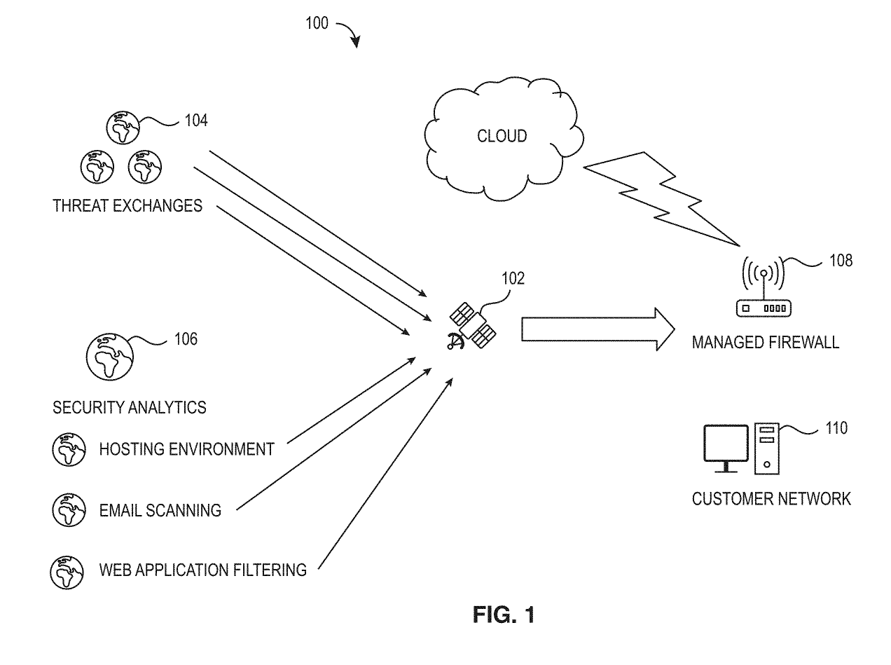

FIG. 1 illustrates an environment 100, wherein various embodiments of the present disclosure can be practiced.

The environment 100 includes an internet security server system 102 that is configured to collect threat related information from at least one threat database 104, and at least one security analytics module 106, and automatically provides the collected information to at least one managed firewall 108 of a corresponding customer network 110. Based on the information received, the at least one managed firewall 108 blocks malicious content from entering into the customer network 110.

In one example, the customer network 110 may be a type of Local Area Network (LAN), in which multiple computing devices may be interconnected within a limited area such as a residence, laboratory, university campus or office building, and has its network equipment interconnected and managed locally. Examples of the computing devices may include, but are not limited to, personal computers, laptops, tablets, smart phones, etc. The customer network 110 may include a wide variety of other network devices such as firewalls, load balancers, and network intrusion detection system.

The firewall 108 is a network security system that monitors and controls the incoming and outgoing network traffic based on predetermined security rules. The firewall 108 establishes a barrier between a trusted, secure internal network such as the customer network 110, and another outside network such as Internet/Wide Area network (WAN). At the firewall 108, the inbound rules (WAN to LAN) restrict access by outsiders to private resources, selectively allowing only specific outside users to access specific resources, and outbound rules (LAN to WAN) determine what outside resources local users can have access to.

The threat databases 104 are compiled by third party software that is configured to run threat detection algorithms to generate a threat index or exchange based on threats such as malware, computer viruses, computer worms, ransomware, scareware, spyware, Trojans and keyloggers. The threat index is a value placed on any host or IP address that the threat detection algorithms marks as suspicious. If the threat index for a particular IP address reaches a threshold, then an alert for that IP address may be generated. The threshold may be predetermined, or dynamic, depending on various factors.

The security analytics module 106 is configured to find threats and malicious content by analyzing hosting environment, scanning email, and filtering web applications. In one example, the security analytics module 106 may include at least one honeypot established by an operator of the server system 102, wherein the monitoring of the honeypot occurs in real-time and is continuously updated. A honeypot is a computer security mechanism set to detect, deflect, or, in some manner, counteract attempts at unauthorized use of information systems. Generally, a honeypot consist of data for example, in a network site, that appears to be a legitimate part of the site, but is actually isolated and monitored, and that seems to contain information or a resource of value to attackers, who are then blocked.

In one embodiment, the internet security server system 102 includes a processor that runs code to automatically collect threat related information from the threat database 104 and the security analytics module 106, at periodic intervals of time, and accordingly, save a list of blacklisted content in a security database housed on the internet security server system 102. The security database is an internal database of the indicators that have been compromised. Examples of the indicators include, but are not limited to, IP address, URLs, file hashes, etc. The security database may include security metrics gathered from an email filtering service, web hosting environment, honeypot servers, and firewall environments. In one embodiment, the threat database 104 sends an email immediately upon a new threat being added, and the received email is parsed. The pushes may come via email and not an actual RSS feed.

In one example, the security database is automatically updated every 15 minutes, or some other predefined time interval or dynamic interval, based on the real-time updates received from the at least one threat database 104, and the security analytics module 106. The blending of two different sources of threats into one security database stored on the internet security server system 102 makes it a unique and proprietary database.

In one embodiment, the security database runs a code to automatically communicate the blacklisted sites to the at least one managed firewall 108, so as to prevent the corresponding customer network 110 from accessing at least one blacklisted content. For example, the security database automatically pushes an updated list of blacklisted content into the managed firewall 108 of a user, proactively blocking these bad actors and protecting the user against the latest attack.

In one embodiment, the push of the threat related information to a client environment happens on a rolling 15 minute schedule. In this embodiment every 15 minutes on the clock, threat information is syndicated out to the customer firewall(s) 108. It could be up to 15 minutes to update the customer with the newest threats or as little as a few seconds, depending on where the new threat alert falls in conjunction with the rolling 15 minute timer. In this manner, there is no scenario where a new reported threat may take more than 15 minutes to be blocked at the customer firewall 108. The internet security server system 102 implements an automated way to control the Blacklist feature of the firewall 108, with globally collected and rapidly aggregated data, which significantly increases the effectiveness of the firewall 108.

In one embodiment, the data can be collected in the security database by parsing emails, web crawling, or manual entry over the life of the product. One unique feature of the present disclosure is that the data collected in the security database at the internet security server system 102 is disseminated in a vendor agnostic way by automatically pushing indicators to the customer firewalls rather than collecting those indicators.

In one embodiment of the present disclosure, the list of blacklisted content is continuously updated in the security database. For example, if an IP address is initially marked as blacklisted in the security database, it can be unmarked as blacklisted, once they have mitigated the infection in their environment.

In another embodiment, the internet security server system 102 is further configured to reactively respond to security alerts generated by third-party software such as ALIENVAULT USM (UNIFIED SECURITY MANAGEMENT)®. When the third-party software generates an alert, the internet security server system 102 is configured to parse the alert, and block the three indicators on the firewall (IP addresses, URLs, file hashes) which may prevent the threat from “calling home” or leaking data to their controlling entity. File hashing currently supports CRC32 as well as other algorithms known or used in the art to generate a file hash, including but not limited to MD5 and SHA-1. Thus, the internet security server system 102 automatically collects and rapidly aggregates global security threat information (indicators) to customer environments.

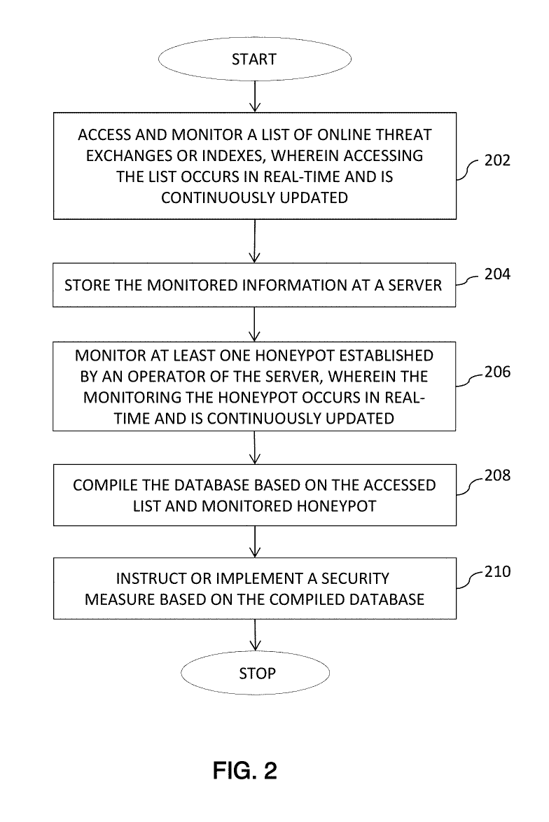

FIG. 2 is a flowchart illustrating a method of providing internet security, in accordance with one embodiment of the present disclosure.

At step 202, a list of online threat exchanges or indexes are accessed and monitored by the internet security server system 102, wherein accessing the list occurs in real-time and is continuously updated.

At step 204, the monitored information is stored at a security database housed on the internet security server system 102. The security database is an internal database of the indicators that have been compromised. Examples of the indicators include, but are not limited to, IP address, URLs, file hashes, etc.

At step 206, at least one honeypot established by an operator of the server system 102 is monitored, wherein the monitoring the honeypot occurs in real-time and is continuously updated.

At step 208, the security database is compiled based on the accessed list and monitored honeypot. The security database may include security metrics, gathered from an email filtering service, web hosting environment, honeypot servers, and firewall environments. In one embodiment, the threat database sends an email immediately upon a new threat being added, and the received email is parsed. The pushes come via email and not actual RSS feed.

At step 210, a security measure is instructed or undertaken based on the compiled security database. In one example, on a rolling 15 minute schedule, the security database syndicates or pushes indicators out to an SSH session to the customer firewall 108 and automatically block a malicious site within the environment, with no human interaction required.

Various embodiments of the present disclosure may be implemented at the internet security server system 102 through code of a few hundred lines, mostly scripted including PHP and MySQL. According to one or more embodiments of the presently disclosed subject matter, the code is entirely in .sh scripts that execute CLI templates. The scripts are encrypted so as to not be human readable any time they contain customer information (e.g. passwords, management IP addresses, personally identifying information, etc.) so that they cannot be misappropriated. Management passwords are entered once during the setup and are not retrievable.

An advantage of the present disclosure is that the internet security server system 102 is robust enough to function as a standalone security solution, and is very beneficial for the small-medium businesses (SMB), as they cannot afford a network operation center (NOC) or security operation center (SOC) due to high costs.

Another advantage of the present disclosure is that, for the large and enterprise market, the internet security server system 102 may serve three main “realized” roles.

Firstly, the IT Director may be able to steadfastly and confidently state to the board, president, or CEO, that all new threats detected and reported on the global landscape are neutralized within 15 minutes, without IT personnel intervention.

Secondly, the efficiency of IT security personnel is greatly improved. The internet security server system 102 could alter security personnel's daily work flow to allow them more time to focus on other problem areas. It also patches problems with firewalls, which have become significantly less effective over the last two decades.

Thirdly, it provides 24/7 security coverage without requiring three shifts of IT workers dedicated exclusively to security.

Yet another advantage of the present disclosure is that in the large business market, the internet security server 102 automatically responds to alerts generated by existing security systems (e.g. USM) combined with the proactive blocking of threats pulled either from monitoring or from open sources. This is a novel defense strategy with a long felt need because it automates what companies have been paying full-time IT personnel to do for years.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

The internet security server system includes a syndicated blacklist capable of utilizing data from any security source that generates a readable log or email notification and automatically updating firewall (blacklist) and switch devices (ACL/port control) with the gathered information. When implemented, the internet security server system provides any environment with an automated cyber security platform that addresses key proactive and reactive strategies essential to any security fabric.

The internet security server system may include a subscription service capable of performing the following actions automatically in an environment, requiring no action from IT personnel:

1. Proactively monitoring globally sourced threat exchanges real time and pushing out newly detected threat indicators to client firewalls

a. Proactive updates happen on a rolling 15 minute schedule

2. Reactively parsing alerts from SIEM and other real time network monitoring solutions (logs or emails) and pushing those threat indicators to the firewall blacklist

a. Reactive firewall updates happen on a rolling 3 minute schedule

3. Reactively parsing alerts from SIEM and other real time network monitoring solutions (logs or emails) and updating the switch(es) in the environment

a. Reactive switch updates happen on a rolling 3 minute schedule.

The internet security server system may include the following individual functions:

1. Proactive monitoring of global threat exchanges

a. Threat exchanges are publicly (or privately) based databases that are hosted on the cloud and made available to subscribers. These databases contain threat indicators and deep-dive information on newly detected threats within the database operators purview

b. Threat indicators are an empirical indicator of a cyber threat, attack or attacker. The three most common threat indicators are:

i. IP Address

ii. URLs

iii. File Hashes

c. The internet security server system monitors these exchanges real time and places newly discovered threat indicators into the internet security server system database

d. This database of newly found threat indicators is automatically uploaded to the client firewall on a rolling 15 minute timer

i. This results in the client environment being hardened against the identified cyber threats before the threat(s) target the client environment.

2. Reactive updating of firewall

a. The internet security server system is capable of parsing alerts that are generated from any SIEM or security solution that generates a parsable log or email alert.

b. The internet security server system extracts the primary threat indicators from these alerts and places them into the internet security server system database

c. This database updates the customer firewall on a rolling 3 minute timer

i. This results in there never being a more than 3 minute gap between a threat being detected in the environment and action being taken against that threat

ii. The updating of the firewall blacklist prevents inbound/outbound WAN communication for packets containing the identified threat indicator(s)

3. Reactive updating of switches

a. The internet security server system is capable of using the same parsed alerts mentioned above (coming from active environment monitor) to also update the switching environment for the customer

b. The internet security server system will automatically update the Access Control List and/or turn off certain ports depending on the threat vector (see example scenario below)

c. Reactive switch updates occur on a rolling 3 minute timer

d. This automatic action by the internet security server system results in the quarantining of infected machines on the LAN—helping to stop the spread of infection throughout the environment

The internet security server system may be configured to accommodate either a push or pull rollout. A push implementation pushes internet security server system database updates every 3/15 minutes from a datacenter to the client firewall. This is most commonly achieved by establishing an SSH connection with the firewall, processing the data and then closing the connection. This is carried out over the cloud in a protected tunnel. A pull implementation installs a virtual or physical host at the client environment. That host will pull updates from our datacenter through a protected channel every 3/15 minutes. The customer firewall is then updated with current database entries over the LAN vs the WAN (push option.) The pull option is more secure & requires a slight increase in configuration.

The internet security server system can parse data from any security appliance/software/solution that generates either a text based log or an email notification. Examples of security driven data sources include, but are not limited to:
Edge firewall
Web application firewall
Email filtering appliance or service (on-prem or hosted)
SIEM/active monitoring software
Threat Exchanges/Databases
SIEM and/or real time monitoring solution

### Example Scenario—Proactive

Assumption: The internet security server system is fully implemented and configured in an environment.

An attacker launches a global phishing attack—being driven by port scans and SMTP messages. This phishing attack is attempting to drive users to click on the anchor link for the URL www.testmyids.com. The attack is reported by a monitored threat exchange based out of Europe at 3:00 pm ET on Friday and identified the malicious URL “www.testmyids.com” as the primary threat indicator. By 3:15 pm ET on that same Friday, the US based internet security server system customer firewall is updated with the primary threat indicator of that attack—“www.testmyids.com” in the blacklist.

At 5:30 pm ET the internet security server system customer environment is targeted by this attack, receiving several SMTP messages targeted towards the customer domain. The data packets containing the malicious URL will be dropped by the firewall and never proceed farther into the environment than the firewall. This means that all employees of the internet security server system customer never receive ANY emails containing the URL “www.testmyids.com”, which was identified as a primary threat indicator in a phishing attack.

The monitoring of the European based threat exchange is automated by the internet security server system. The updating of the customer firewall blacklist with the newly discovered threat indicator is automated. The entire protection scenario plays out automatically, never requiring IT personnel to intervene or take action.

### Example Scenario—Reactive

Assumption: The internet security server system & ALIENVAULT USM® are fully implemented and configured in an environment.

An attacker launches a targeted attack on the customer environment at 4:00 pm ET. The attacker is based out of France and is launching his attack from an environment with the public IP 1.2.3.4. The attack is a payload delivery directed at an end user PC within the customer environment. The source IP Address of the attack is a currently clean IP and is not an offending entry in any monitored threat exchange. The attack is successful in delivering its payload, a piece of malware that collects contact lists and self-propagates.

Shortly after successful delivery of the payload ALIENVAULT USM® detects the threat through Host IDS and collects relevant information, including the source of the attack and the targeted machine(s). ALIENVAULT USM® generates an alarm—creating a log entry and an email notification. The alarm identifies two key pieces of information: The IP of the attack source (1.2.3.4) and the internal IP of the infected machine (10.10.10.5).

The internet security server system immediately parses the log entry and adds the identified attack source IP address to the internet security server system database. Within 3 minutes of this happening the customer firewall blacklist is updated which will immediately stop any communication the attack has with the infected machine.

For customers with multiple locations, all locations that have an active internet security server system subscription to their firewall will be updated simultaneously when the original attack location is updated. The internet security server system database is centralized and will push the identified threat indicator(s) out to all customer locations within the same 3 minutes.

This is particularly relevant to Government and related industries that may have hundreds or thousands of locations. It is rare that a targeted attack will target only a single facility, instead the attack will target all of the facilities in that Department (Energy, Homeland, Transportation etc.) in hopes of finding one vulnerability they can exploit.

With the internet security server system all locations have their edge security updated with the identified threat indicator almost immediately after the spearhead hits the first location. This allows the other locations to be updated before the attack hits, turning what would quickly be a reactive scenario into a proactive success.

Simultaneously to the firewall being updated, the internet security server system also adds the internal IP address of the infected machine to the database (10.10.10.5). Within 3 minutes of this IP being added to the system, the switch ACL will be updated to disallow all inbound/outbound traffic on that IP address. This effectively quarantines the machine on the network and helps prevent the propagation of the infection to other machines on the network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The computer may include a tablet, laptop, desktop, or it may include one or more servers used to implement cloud services.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A method of providing internet security, the method comprising:
accessing and monitoring a list of online threat exchanges or indexes, wherein accessing the list occurs in real-time and is continuously updated;
storing the monitored list at a server;
monitoring at least one honeypot established by an operator of the server, wherein the monitoring of the honeypot occurs in real-time and is continuously updated;
compiling a security database based on the accessed list and monitored honeypot; and
instructing or implementing security measures based on the compiled database.

2. The method of claim 1, further comprising automatically updating the security database every 15 minutes.

3. The method of claim 1, wherein implementing security measures comprises automatically blocking malicious content from entering into a customer network.

4. The method of claim 1, wherein the security database is a database of one or more indicators that have been compromised.

5. The method of claim 4, wherein the one or more indicators include at least one of IP addresses, URLs, and file hashes.

6. The method of claim 5, wherein the file hashes are created using a CRC32 file hashing algorithm.

7. The method of claim 1, further comprising blending indicators from at least one threat exchange and a security analytics module into the security database and storing the security database on the server.

8. The method of claim 4, further comprising pushing indicators out though an SSH session to a firewall and automatically blocking a malicious site within an environment.

9. The method of claim 1, wherein implementing security measures is executed through code of less than a thousand lines of scripted PHP and MySQL.

10. The method of claim 1, wherein implementing security measures is executed through code in .sh scripts that executes CLI templates.

11. An internet security server comprising:
a memory to store one or more instructions; and
a processor in communication with the memory, and configured to execute the one or more instructions to:
access and monitor a list of online threat exchanges or indexes, wherein accessing the list occurs in real-time and is continuously updated;
store the monitored list at the server,
monitor at least one honeypot established by an operator of the server, wherein the monitoring of the honeypot occurs in real-time and is continuously updated;
compile a security database based on the accessed list and monitored honeypot; and
implement a security measure based on the compiled database.

12. The server of claim 11, wherein the security database is automatically updated every 15 minutes.

13. The server of claim 11, wherein the security measure comprises automatically blocking malicious content from entering into a customer network.

14. The server of claim 11, wherein the security database is a database of one or more indicators that have been compromised.

15. The server of claim 14, wherein the one or more indicators include at least one of IP addresses, URLs, and file hashes.

16. The server of claim 15, wherein the file hashes are created using a CRC32 file hashing algorithm.

17. The server of claim 11, wherein the security database is stored on the server and comprises a combination of indicators from at least one threat exchange and a security analytics module.

18. The server of claim 15, wherein the processor is configured to execute instructions to push indicators out though an SSH session to a firewall and automatically block a malicious site within an environment.

19. The server of claim 11, wherein the instructions comprise code of less than a thousand lines of scripted PHP and MySQL.

20. The server of claim 11, wherein the instructions are executed through code in .sh scripts that execute CLI templates.
